(19) United States
(12) Patent Application Publication
(10) Pub. No.: US 2002/0184820 A1
(43) Pub. Date: Dec. 12, 2002

(54) Plant growing system

(76) Inventor: Terry L. Mauney, Sunnyvale, CA (US)

Correspondence Address: DICKSTEIN SHAPIRO MORIN & OSHINSKY LLP, 2101 L STREET NW, WASHINGTON, DC, 20037-1526, US

(21) Appl. No.: 10/141,830

(22) Filed: May 10, 2002

Related U.S. Application Data
(60) Provisional application No. 60/297,172, filed on Jun. 7, 2001.

(51) Int. Cl. A01G 31/00

(52) U.S. Cl. 47/60

(57) ABSTRACT

A substantially automated, sealable, soiless plant growing apparatus for maximizing plant growth by maximizing light and CO₂ consumption by the plant and controlling the plants reproductive cycle by controlling its environment. A light timer controls the grow light and can simulates a photo period. A pump timer can control the watering cycle and drainage switch. The plant growing environment can be fully, partially, or un-controlled in conditions such as light, temperature, humidity, irrigation, and atmosphere.

This application claims priority to provisional application No. 60/297,172, entitled PLANT GROWING APPARATUS, filed Jun. 7, 2001, the entirety of which is incorporated by reference.

### BACKGROUND OF THE INVENTION

1. Field of the Invention

The present invention relates generally to a plant growing system and more specifically to a substantially automated, sealable, soil-free plant growing apparatus for maximizing plant growth and controlling plant reproductive cycles by controlling the environment.

2. Description of the Prior Art

There is a need for a plant growing system that can be used in the home, as a gardening system, and is sufficiently automated so that users can leave the chamber for several days or weeks without worry about daily maintenance. There is also a need for a growth apparatus capable of performing controlled experiments relating to plant physiology and for maximizing the production of cultivated plants in a given period of time and utilizing a given amount of space.

Growing complex fruits or vegetables has special requirements and is not easily performed indoors. The great majority of cultivated plants are grown outdoors to take advantage of natural sunlight, precipitation, soil, and available space. However, there are disadvantages to cultivating plants outdoors. It is difficult to perform precisely controlled experiments outdoors to determine optimum conditions of temperature, nutrition, solution pH and light spectra or to determine whether genetic or environmental factors are responsible for certain observed differences between plants. The outdoor environment is unpredictable. Because of these problems, many scientific experiments cannot be performed in a natural, outdoor setting or even in an outdoor setting in which conditions are partially controlled through use of irrigation, fertilizer, or using other prior art plant growth systems

In view of the problems associated with cultivating plants outdoors for scientific purposes and for the purpose of maximizing plant production, significant efforts have been made for many years to develop controlled environment apparatuses capable of performing carefully controlled experiments relating to plant physiology and of regulating and optimizing the conditions of plant growth. It can be appreciated that plant growing systems have been in use for years. Commercially available growth systems, such as the Phototron (U.S. Pat. No. 4,850,135), provide a partially controlled environment and have been available to businesses and universities for many years. These commercially available growth systems are generally expensive, hard to install, bulky, heavy, require specialized installation, maintenance and service, and are generally not suitable for consumer use. A problem with prior art plant growing systems is that they lack a built-in irrigation or planting system. Another problem with conventional plant growing apparatuses is that they lack built-in air and light-tight chambers.

The prior art devices are generally not suitable for maximizing plant growth by maximizing light and CO₂ consumption by the plant and controlling the plants reproductive cycle by controlling its environment.

A substantially automated, sealable, soil-free plant growing apparatus would substantially depart from the conventional concepts and designs of the prior art, and in so doing would provide an apparatus suitable for the purpose of maximizing plant growth by maximizing light and CO₂ consumption by plants and controlling plant growth and reproductive cycles by controlling the growing environment.

### SUMMARY

The invention provides a substantially automated, sealable, soil-free plant growing system, which can be utilized for maximizing plant growth by maximizing light and CO₂ consumption by the plant(s) and controlling plant growth and reproductive cycles by controlling the environment.

The plant growing system generally includes an apparatus for growing a plant having an aerial and non-aerial potion, which comprises a housing including first, second, and third regions. The second region includes a plant support and is structured to receive the aerial portion of the plant. The third region includes an automated irrigation system and is structured to provide water and nutrients to the plant and to receive the non-aerial portion of the plant. The apparatus also includes a chamber door to the second region, which is received within said housing upon opening and creates a partially air-tight seal for the second region when closed. The partially air-tight seal forms an environment containment system that prevents the atmosphere within the second region from freely mixing with the external environment. The first region can include lighting means for providing photo radiation for the plant.

The system can include a housing, plates, supports, roller(s), door(s), barrier(s), a pump, lighting, tubing, and timers. The housing can be of a plastic cylindrical shape with cutouts for an access door, ventilation, and electrical components. There can be four circular plates with cutouts, including a bottom plug, a planter, a light plate, and a top plug. The roller(s) can consist of vertically oriented plastic tubing. The semi-circular door(s) can be made of flexible sheet plastic, which may be extruded or thermoformed. The chamber barrier can be made of clear sheet plastic. The electrical pump can provide irrigation, circulation, aeration, and drainage. The grow lights, ceramic socket, and ballast can form a lighting system. The CO₂ and air tube(s) can provide CO₂ for the growing chamber and aeration for the nutrient solution. The light timer can control the grow light and photo period. The watering timer can control the watering cycle and drainage.

The components of the invention can be arranged to exert a vertical and horizontal pressure, which can combine to create a substantially or partially air-tight and light-tight chamber, yet provide access doors for maintenance and visibility. The air-tight aspect of the chamber can prevent the environment within the chamber from freely mixing with the environment external to the chamber. The light-tight aspect can provide for more controlled light in intensity and spectral wavelength. The housing, in combination with the circular plates and vertical supports, can be partitioned into three distinct regions: light, chamber, and tank. The light region can provide one or more timed light sources, can reflect light back into the chamber region, and utilize multiple light types and wattages. The chamber region can receive and contain the plant(s) and provide for CO₂ enrichment. The tank region can contain the plant roots and provide an irrigation system for delivering aerated, nutrient-rich solution to the roots. These areas combine to substantially eliminate daily maintenance, maximize plant growth, and minimize operating cost while providing an esthetic, quiet, clean, easy-to-use, modular plant growing apparatus.

The invention can substantially eliminate solution leakage and prevent roots from clogging a feed or drain. The irrigation system can allow the plant roots to obtain water directly from a reservoir in case of electrical failure, ensures root saturation upon watering, utilize one pump to simultaneously saturate the root system, circulate the solution, aerate the solution, and drain the solution, which can minimize costs and energy consumption, and maintain nutrient solution temperature, pH, and electrical conductivity. A sump area can be provided for fully draining the tank.

The above-noted and other features and advantages of the invention may be better understood upon a reading of the Detailed Description with reference to the appended drawings.

### BRIEF DESCRIPTION OF THE DRAWINGS

FIG. 1 is a partial cut-away perspective view of a plant growing apparatus in accordance with a preferred embodiment of the invention.

FIG. 2 is a view taken along section line II-II of FIG. 1.

FIG. 3 is view like FIG. 1 showing the invention in use.

FIG. 4 is view like FIG. 3.

### DETAILED DESCRIPTION OF PREFERRED EMBODIMENTS

The invention provides a substantially automated, sealable, soil-free plant growing apparatus, which can be utilized for maximizing plant growth by maximizing light and CO₂ consumption by the plant(s) and controlling plant growth and reproductive cycles by controlling the environment.

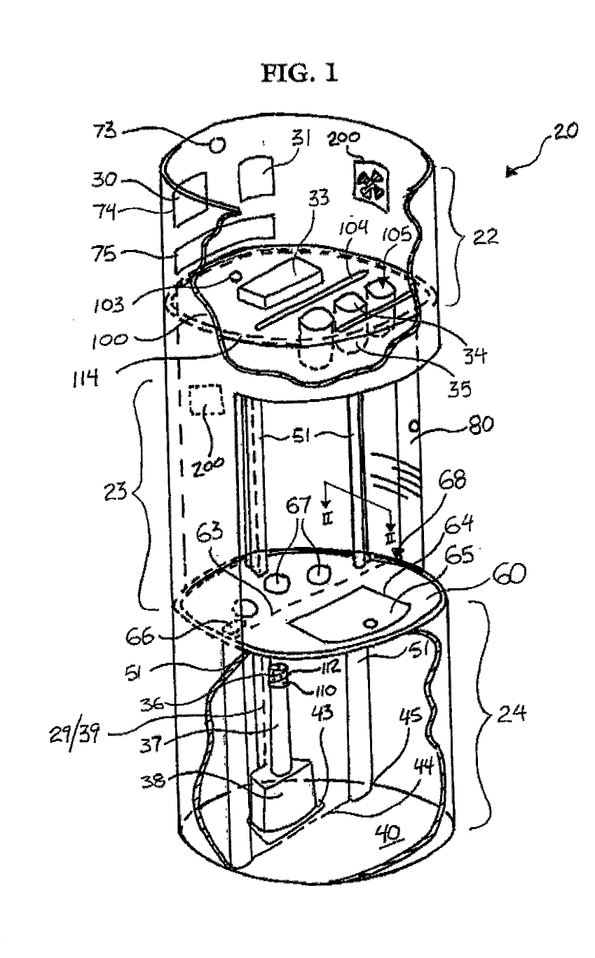

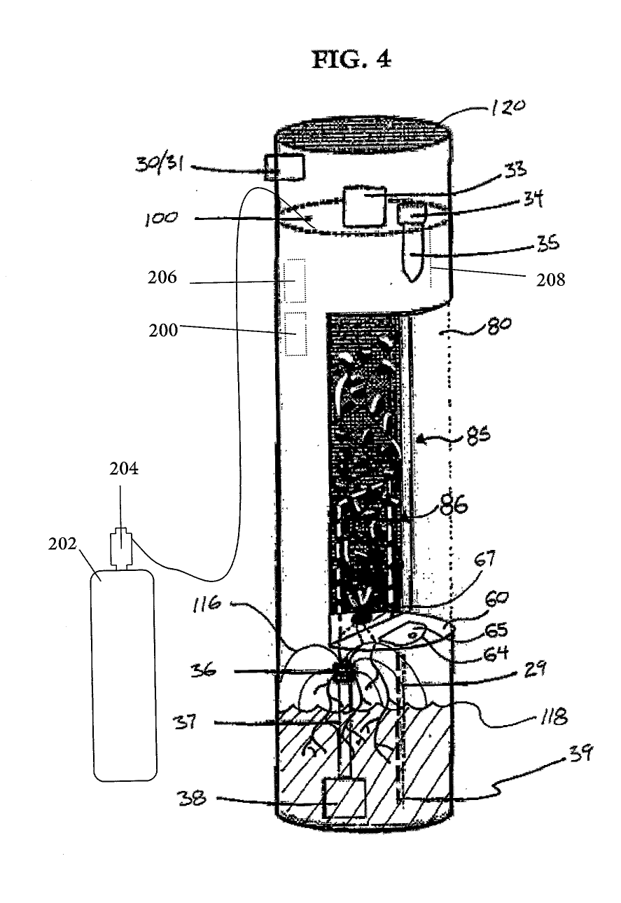

Now referring to the drawings, where like reference numbers denote like features of the invention, FIG. 1 shows a perspective view of the apparatus 20 constructed in accordance with an embodiment of the invention. The structure of the apparatus 20 can be made of PVC pipe or other materials, available commercially, having similar qualities. The environment within the apparatus 20 is partially controlled when the semi-circular door 80 is open, allowing exposure to the surrounding atmosphere. The apparatus 20 can be more fully controlled in its internal environment upon closing the semi-circular door 80, and further still controlled when utilizing a chamber barrier 85 (see FIG. 4).

The apparatus 20 housing can comprise a light region 22, a chamber region 23 and a tank region 24. The housing can be a single unit structure, or as an alternative, the housing can be separated into component units that can be combined to form the complete apparatus 20 structure. Lighting means and electrical distribution can be provided by the light region 22. The chamber region 23 can be where the plants are grown and provides either a controlled, partially controlled, or uncontrolled environment depending on the users preferences or needs. The tank region 24 can provide for a solution reservoir, irrigation system, and space for roots to grow.

The light region 22 can be separated from the chamber region 23 by a light plate 100. The light plate 100, if desired, can create a light-tight and air-tight barrier between the light region 22 and chamber region 23. The light plate 100 can serve as a structure for supporting features of the invention provided within the light region 22.

The light region 22 can incorporate a light timer 30 and a watering timer 31. These timers 30 and 31 can consist of programmable lamp or appliance timers such as those made by Intermatic Incorporated and can be held in place within cutouts 30 through the housing. The controls and display for such timers 30 and 31 can be exposed outside the housing for manipulation by a user.

The light timer 30 can control the light sources. These light sources can include a variety of different types and sizes of grow lights 35, such as, but not limited to, High Pressure Sodium (BPS), Metal Halide (MH) and Sulfur Bulb. The light timer 30 can be utilized with just one or several grow lights 35 depending on the needs and preferences of the user and the desired light spectral characteristics necessary to mimic “Times Of Day” or phase of plant growth. The light timer 30 can also provide a manual on/off switch for the grow lights 35. Additionally, the light timer 30 can be used to control the CO₂ input, because a plant's ability to utilize CO₂ generally coincides with its light cycle. The CO₂ can be supplied by a device internal or external to the apparatus 20 and the CO₂ can be generated by means known in the art.

The watering timer 31 can control the watering cycle and drainage feature. The watering timer 31 can be programmed to ensure that the root system is maintained at substantially 100% saturation. The size and density of the root system may determine the watering period. A manual on/off switch can be provided by the watering timer 31 to manually control the pump 38, which, when properly configured can be used to drain the solution tank. The manual on/off switch can also be used to continuously water the roots, if desired.

The grow lights 35 can be the light source for the plant within the chamber region 23. Multiple grow lights of different sizes and types may be added. Light ballasts 33 can be associated with the grow lights 35 and can be housed within the light region 22 and received by the light plate 100. The ballasts 33 can generate heat and can be air cooled through vent holes 75 that can be provided in the housing of the apparatus 20.

Light receptacles 34 can penetrate through the light plate 100 through a plurality of holes 105. These light receptacles 34, as well as other structures on the light plate 100, can provide a reflective geometry that can substantially transmit the majority of the light generated by the grow lights 35 directly into the chamber region 23. Additionally, the bottom of the light plate 100, as well as other structures in close proximity or attached thereto, can be similarly reflective to further support the lighting of the chamber region 23.

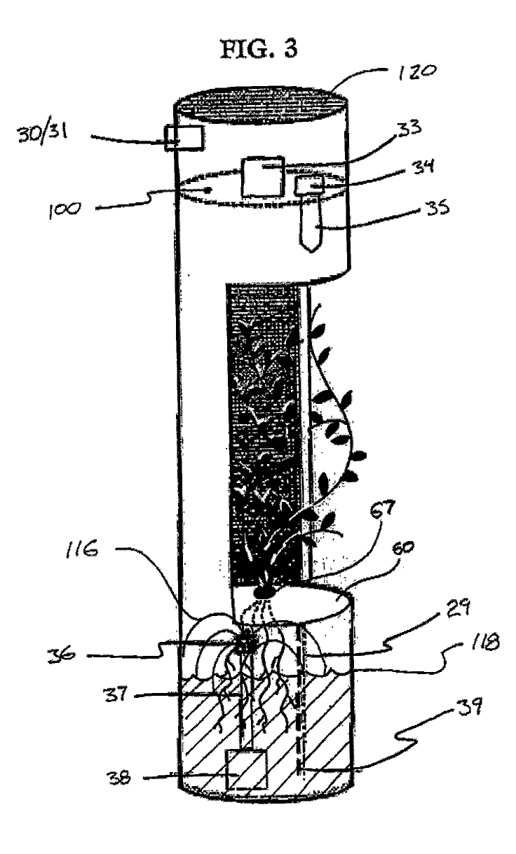

The light plate 100 can also incorporate a tube hole 103 that can provide a path for a CO₂ tube 39 to the inside of the isolated chamber region 23. Additionally, the light plate 100 can provide vent holes 104 to allow heat to escape from the chamber region 23, if desired. One or more fans 200 can be included within the light region 22 to circulate air and cool the apparatus 20. The light plate 100 can be supported by vertical supports 51, which can extend to the bottom of the apparatus 20, as will be further discussed below. A door track 114 can also be incorporated into the underside of the light plate 100 for receiving the top of a semi-circular door 80, which will be further described below. A slot 73 for a power cord can be provided in the light region 22. A single main power cord can be used to power the entire apparatus 20. The top 120 of the apparatus 20 (see FIGS. 3 and 4) at the light region 22 can be removable so as to provide access to the components in the light region 22.

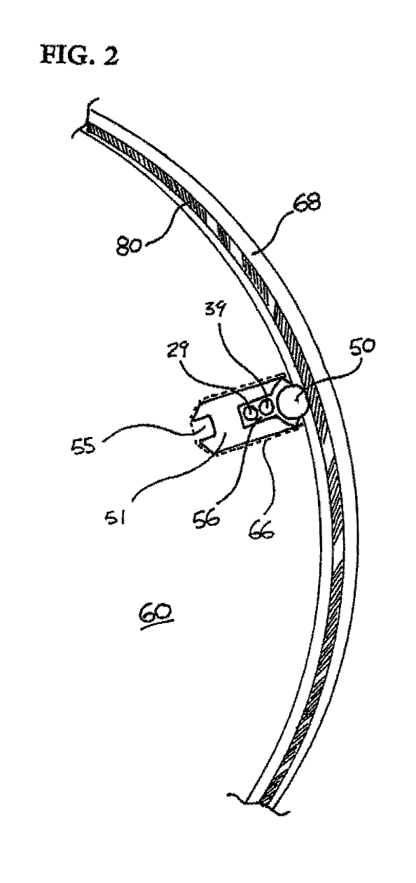

As noted above, FIG. 1 also illustrates the chamber region 23 of the apparatus 20. It is within the chamber region 23 that the aerial portion of a plant e.g., the stem and foliage sections, can be contained and grow. Access to the chamber region 23 can be via a semi-circular door 80, that when closed creates a partially air-tight chamber, and can create a light-tight chamber as well since the semi-circular door 80 can be made of a light reflective material. There can be more than one semi-circular door 80 if desired. The semi-circular door 80 will be discussed in greater detail below in reference to the planter 60 shown in FIG. 1 and in reference to FIG. 2.

The planter 60 shown in FIG. 1 is a barrier between the chamber region 23 and the tank region 24. The planter 60 can provide a receptacle for holding seeds, plant seedlings, and the entire plant during growth. The planter 60 can contain holes 67, which can hold net-pots, which in turn can hold potting medium such as rock wool, sponge, or other media suitable for supporting seeds. The aerial portion of a plant, e.g., stem and foliage, can grow out of the top area of the planter 60 into the chamber region 23 and the non-aerial portion of a plant, e.g., roots, can grow down in the tank region 24 below. The planter 60 can provide an access opening 64 to the tank region 24 to allow a user access for viewing the tank region 24 and, via an access door 65, the user can control the tank region 24 by, e.g., inspecting the nutrient solution, adjusting the pH of the solution, draining or filling the solution or inspecting the root system, etc. The top side of the planter 60 can provide a chamber barrier slot 63 that can be used for receiving a chamber barrier 85, which will be discussed below in reference to FIG. 4.

The planter 60 can provide vertical support holes 66, which penetrate the planter 60 and allow vertical supports 51 to pass through to the tank region 24. The planter can incorporate a semi-circular door track 68, which can operate as a track at the outer edge of the planter 60 for the semi-circular door 80. The semi-circular door 80 can be received into this track and travel within the track when opened or closed. The semi-circular door track 68 can run the entire circumference of the planter 60 so that the semi-circular door 80 can be received within the apparatus 20 when opened.

Also within the chamber region 23, there can be positioned one or more fans 200 to circulate air within the chamber or to aid in ventilating the chamber if so desired. Any such fans 200 can be powered by the same common power source as the components within the light region 22.

FIG. 1 shows the tank region 24 of the apparatus 20. As noted above, the tank region 24 is separated from the chamber region 23 by the planter 60. The tank region 24 can contain a nutrient solution, which can be water with nutrient concentrate additives that are commonly available. The pH of the nutrient solution can be maintained with pH tablets, also commonly available. As noted above, the roots of the plants growing within the chamber region 23 can grow down into the tank region 24 and dangle within the nutrient solution and open space within the tank region 24 (see FIGS. 3 and 4). The root systems can also be sprayed with the solution by an irrigation system within the tank region 24. This irrigation system can include a hose-sprayer fitting 36 and a riser pipe 37, both connected to a pump 38, which can be positioned within a sump area 43. Alternatively, the pump 38 can be connected to a single tube, which can function like the riser pipe 37 and be directionally positioned and securely fixed within the tank region 24 to irrigate the roots.

The hose-sprayer fitting 36 can be a multiple function component that can serve to form a spray 116 pattern (see FIGS. 3 and 4) to water the root system. Holes 110 through the hose-sprayer fitting can provide a means for the nutrient solution to exit the hose-sprayer fitting 36 and form the spray 116. The hose-sprayer fitting 36 can provide a hose thread 112 on its outside surface to enable a common hose to be attached to drain the tank region 24. The hose-sprayer fitting 36 can be attached to the riser pipe 37, which can attach to the pump 38 on the lower end. The pump 38 can be a multi-use component mounted in the tank region 24 on top of a bottom plug 40, which can form the bottom of the apparatus 20, inside the sump area 43 for maximum drainage when changing the solution. The tube of the alternative embodiment noted in the preceding paragraph can be long enough to exit the tank region 23 through the access opening 64 for an alternative means of draining the tank region 23. The pump 38 can be controlled by the watering timer 31 during periodic watering intervals and when draining the solution, or can operate continuously. The pump 38 can also serve as an aerator by drawing in air via the air tube 39 and agitating the water, which can thoroughly mix with the air causing the solution to become aerated, which is beneficial for root growth and development. The air tube 39 can enter from the backside of the light region 22, as noted above, and travel down through the chamber region 23 via a channel 56 in a vertical support 51 and into the tank region 24 down into the sump area 43 via a air tube channel 44, where the pump 38 can mix the air with the solution, thereby, aerating the solution.

The bottom plug 40 can be received into the bottom portion of the tank region 24 and can be permanently affixed to the housing of the apparatus 20. The interior of the bottom plug 40 can provide slots 45 for the vertical supports 51. Each vertical support 51 can slide into a slot 45, which can provide stability to the vertical support 51 and apparatus 20 structure. In addition, the bottom plug 40 can also provide a recessed area forming the sump area 43 for improved drainage and the air tube channel 44, which receives the air tube 39.

Now referring to FIG. 2, the interaction between the semi-circular door 80, the planter 60, and the vertical supports 51 is shown in greater detail. As noted above, the semi-circular door 80 is received within the semi-circular door track 68 and can slide therein to open and close. A similar door track 114 can be provided in the underside of the light plate 100, as noted above. The vertical support 51, which can support the planter 60 and the light plate 100 in the vertical direction, can pass through vertical support holes 66 of the planter 60 and can also pass through vertical support holes of the light plate 100 (not shown). Semi-circular door rollers 50 can be incorporated into each of the vertical supports 51 and can be made of a flexible plastic tubing. The semi-circular door rollers 50 can apply pressure to the semi-circular door 80 and provide roller motion to the inside of the semi-circular door 80 when opening and closing. This pressure contributes to the air-tight seal of chamber region 23 in the horizontal direction. The vertical supports 51 can also provide a channel 56 that allows a pump power cord 29 and the air tube 39 (and additional tubes or cords if desired) to pass from the tank region 24 through the chamber region 23 and into the light region 22. The opposite side of the vertical supports 51 from the channel 56 can be a chamber barrier vertical slot 55, which provides a slot for a chamber barrier 85 to slide into and thereby divide the chamber region 23 for providing a more controlled internal environment.

FIGS. 1 and 2 show the semi-circular door 80, which can be one or more flat sheets of thin ridged, but flexible plastic. The thickness of the plastic should be such as to provide flexibility to ride in the curved semi-circular door track 68 and conform to the cylindrical shape of the apparatus 20, but ridged enough not to distort when being opened or closed. Thermoforming or extrusion may be used to construct the semi-circular door 80 of light-reflecting PVC plastic or of a clear transparent plastic for viewing the interior of the chamber region 23 without substantially disturbing the internal environment. The semi-circular door 80, when open, can provide access to the chamber region 23 and tank region 24. When opening or closing, the semi-circular door 80 can pass between the vertical supports 51 and the housing of the apparatus 20. When the door is opened it can roll substantially out of view. The door 80 can be closed by sliding along the door track 68 past the semi-circular door roller 50, which squeezes or applies pressure in a horizontal direction, contributing to the seal for the chamber region 23. The partially air-tight seal discussed herein provides for an internal environment that is contained, at least partially, within the chamber region 23 of the apparatus 20 so that the internal environment (e.g., atmosphere, temperature, humidity, etc.) does not freely mix with the environment external to the apparatus 20.

Now referring to FIG. 3, it is shown more clearly how a plant can be contained within the apparatus 20. As shown, the plant can be rooted within a hole 67 in the planter 60. The plant's roots can grow downward and dangle into the tank region 24. The stem and foliage grow upwards toward the grow lights 35 within the chamber region 23. It can be observed how the irrigation system (e.g., the hose-sprayer fitting 36, riser pipe 37, and pump 38) can supply the roots within the tank region 24 with a spray 116 of nutrient solution. The roots can also be partially submerged within the solution contained by the tank region 24. A nutrient solution level 118 can be maintained at a sufficient height to allow the roots to be partially submerged therein. In such an arrangement, if the semi-circular door 80 remains closed at all times, the internal environment of the apparatus can be partially controlled as to atmosphere and the semi-circular door 80 reflects light back into the chamber region 23. If the semi-circular door 80 is opened infrequently, the internal environment is partially controlled.

FIG. 4 shows an embodiment of the invention where the internal environment of the apparatus can be fully controlled at all times. This embodiment utilizes a chamber barrier 85. The chamber barrier 85 can be made of clear plastic, and can provide for a semi-permanent, substantially air-tight compartment by dividing the chamber region 23. The chamber barrier 85 can be received within the chamber barrier slots 55 of the vertical supports 51 and within the chamber barrier slot 63 of the planter 60. The chamber barrier 85 can incorporate a door 86 for access to the partitioned chamber region 23. The chamber barrier door 86 can be formed to slide upwards into the chamber region 23 or other equivalent access means can be substituted. With the chamber barrier 85 in place and the chamber barrier door 86 closed, the interior of the chamber region 23 can virtually be a fully controlled environment (e.g., in temperature, humidity, air quality, CO₂ content, light, etc.). In this type of operation, the semi-circular door 80 can be closed as well to provide reflected light and the system of fans 200 can circulate air within the chamber region 23. Additionally a reflector 208 can be positioned to reflect light from the grow light 35 directly into the subdivided growing chamber toward a growing plant.

Use of the chamber barrier 85 can provide an isolated environment that is particularly suitable for CO₂ enhancement and other environmental control of the inside atmosphere. An external CO₂ tank 202 with a regulator 204 is shown in connection with the embodiment of FIG. 4. Also shown is a fan 200 and a chamber ionizer 206, which can control odor emissions related to the growing plant. The chamber barrier 85 allows an environment that provides for maximum accelerated or enhanced growth of plants. The chamber barrier 85 can be used when the user desires the chamber environment to be fully controlled and when CO₂ is going to be used. It also provides a maximized partitioning of the chamber area 23 so when plants are fully-grown they are not able to grow around the light source and block it off. The chamber barrier 85 can be made of a clear plastic such as Acrylic or Polycarbonate. This barrier 85 can also provide for aroma control and prevent any emissions, such as pollen, from the chamber region 23. Note, however, that full access to the tank region 24 by the access opening 64 and door 65 is still possible when the chamber barrier 85 is in place.

The foregoing description of the invention is considered only as illustrative of the principles of the embodiments of the invention. Since numerous modifications and changes will be or become readily apparent to those skilled in the art, the invention is not limited to the illustrated and described embodiments, but only by the scope of the appended claims and equivalents thereto.

What is claimed as new and desired to be protected by Letters Patent of the United States is:

1. An apparatus for growing a plant having an aerial and non-aerial potion, comprising
a housing including first, second, and third regions, said second region including a plant support and being structured to receive the aerial portion of the plant, said third region including an automated irrigation system and being structured to provide water and nutrients to the plant and to receive the non-aerial portion of the plant; and
a chamber door to said second region, said chamber door being received within said housing upon opening and creating a partially air-tight seal for said second region when closed.

2. The apparatus of claim 1, wherein said housing is a single unit.

3. The apparatus of claim 1, wherein said first region includes an automated photo radiation system.

4. The apparatus of claim 1, wherein said chamber door is a semi-circular door received within a track along an inside perimeter of said housing.

5. The apparatus of claim 4, further comprising a plurality of vertical supports within said housing, said vertical supports providing structural integrity to said apparatus and contributing to the partially air-tight seal created by said chamber door.

6. The apparatus of claim 3, wherein said automated photo radiation system is controlled by a first timer and said automated irrigation system is controlled by a second timer.

7. The apparatus of claim 1, further comprising a CO₂ source capable of providing CO₂ gas to said second region.

8. The apparatus of claim 7, wherein said CO₂ source and said automated photo radiation system are both controlled by a timer.

9. The apparatus of claim 1, wherein said first region is separated from said second region by a light plate.

10. The apparatus of claim 9, wherein said light plate creates a partially light-tight and air-tight barrier.

11. The apparatus of claim 3, wherein said photo radiation system comprises at least one grow light.

12. The apparatus of claim 1, wherein said second region is separated from said third region by a planter.

13. The apparatus of claim 12, wherein said planter comprises at least one receptacle, said receptacle having a structure to support the plant and allowing roots of the plant to extend into said third region.

14. The apparatus of claim 12, wherein said planter comprises an access door to said third region.

15. The apparatus of claim 1, further comprising a plurality of air circulators within said first and second regions.

16. The apparatus of claim 1, wherein said automated irrigation system is controlled by a timer.

17. The apparatus of claim 16, wherein said automated irrigation system comprises a pump and a tube structured to spray a portion of the plant within said third region with a liquid contained by said third region.

18. The apparatus of claim 17, wherein said tube terminates in a fitting having threads for attaching a second hose and having holes allowing said liquid to escape during spraying.

19. The apparatus of claim 18, wherein said automated irrigation system further comprises an aerator for said liquid.

20. The apparatus of claim 1, wherein said third region is structured to contain a liquid such that roots of the plant can be at least partially submerged within said liquid.

21. The apparatus of claim 1, wherein said automated irrigation system is capable of draining a liquid contained within said third region by pumping.

22. The apparatus of claim 1, further comprising a chamber barrier that partitions said second region into a first and second section, said first section being suitable for containing the plant and being substantially environmentally controlled, said second area providing access to said third region.

23. The apparatus of claim 22, wherein said chamber barrier includes an access door to said first section.

24. A plant growing device, comprising:
a cylindrical housing;
a lighting chamber including at least one light source;
a first controller, said first controller being programmable and in electrical communication with said light source for controlling the functioning of said light source;
a supporting plate, said light source being secured to said cylindrical housing via said support plate;
a growth chamber coupled to said lighting chamber, said growth chamber having an interior environment and including a removable chamber barrier capable of partitioning said interior environment, said interior environment being optically exposed to said light source, said removable chamber barrier including a barrier access door;
a chamber door, said chamber door providing access to said interior environment of said growth chamber, wherein said chamber door is structured to be recessed within said cylindrical housing upon opening and making said interior environment partially air-tight upon closing;
a planter, said planter capable of supporting a plant and comprising a planter access door;
a tank coupled to said growth chamber and being accessible via said planter access door, said tank being structured to contain a liquid and to receive plant roots, said tank including an irrigation system structured to provide the plant roots with water and nutrients by partial submersion of said roots in said liquid and by spraying said liquid on said roots; and
a second controller, said second controller being programmable and in electrical communication with said irrigation system to control the functioning of said irrigation system.
